(19) United States
(12) Patent Application Publication
(10) Pub. No.: US 2011/0107367 A1
(43) Pub. Date: May 5, 2011

(54) System and method for broadcasting personal content to client devices in an electronic network

(75) Inventors: Nikolaos Georgis, San Diego, CA (US); Fredrik Carpio, San Diego, CA (US); Milton Frazier, San Marcos, CA (US)

(73) Assignees: Sony Corporation; Sony Electronics Inc.

(21) Appl. No.: 12/589,923

(22) Filed: Oct. 30, 2009

(51) Int. Cl. H04N 7/025; G06F 15/16

(52) U.S. Cl. 725/32; 709/203

(57) ABSTRACT

A system and method for supporting personal content distribution in an electronic network includes a source client device that selects and transfers personal content over a back channel. A content server receives and processes the personal content according to specific transmission instructions to thereby generating a corresponding content item. A high-power transmitter then wirelessly broadcasts the content item to one or more target client devices that receive and process the content item to retrieve the personal content.

### BACKGROUND SECTION

1. Field of the Invention

This invention relates generally to techniques for managing electronic information, and relates more particularly to a system and method for broadcasting personal content to client devices in an electronic network.

2. Description of the Background Art

Implementing effective methods for managing electronic information is a significant consideration for designers and manufacturers of contemporary electronic devices. However, effectively managing information utilized by devices in an electronic network may create substantial challenges for system designers. For example, enhanced demands for increased device functionality and performance may require more system processing power and require additional software resources. An increase in processing or software requirements may also result in a corresponding detrimental economic impact due to increased production costs and operational inefficiencies.

Furthermore, enhanced device capability to perform various advanced data management operations may provide additional benefits to a system user, but may also place increased demands on the control and management of various system components. For example, an enhanced electronic network device that effectively manages electronic content information may benefit from an effective implementation because of the large amount and complexity of the digital data involved.

Due to growing demands on system resources and substantially increasing data magnitudes, it is apparent that developing new techniques for managing information in electronic networks is a matter of concern for related electronic technologies. Therefore, for all the foregoing reasons, developing effective techniques for managing information in electronic networks remains a significant consideration for designers, manufacturers, and users of contemporary electronic devices.

### SUMMARY

In accordance with the present invention, a system and method for supporting personal content distribution in an electronic network are disclosed. In one embodiment, a source device user of a source client device initially selects and uploads personal content to a content server via a back channel. In certain embodiments, the back channel may include an Internet connection between the source client device and the content server. In certain embodiments, the source device user may also provide appropriate transmission instructions for handling the uploaded personal content in any effective manner. For example, default transmission instructions may be provided when the source device user registers for a user account with the content server. Furthermore, special transmission instructions (for example, instructions identifying specific authorized target client devices) may be specified for each upload of personal content.

The content server determines whether a transmit request has been received to request a broadcast of the uploaded personal content from a transmitter to the target client devices. The transmit requests may be generated by any appropriate request source including, but not limited to, the source client device and one or more target client devices. The content server processes the transmit request to create a content header that is configured depending upon any pre-existing transmission instructions and/or specific information and instructions provided by the request source. For example, a source client device may identify specific target client devices that are authorized to receive the personal content, or a target client device may specify an appropriate transmission time or transmission speed. The content server may attach the content header to the personal content to thereby form a content item for broadcast by the transmitter.

The content server also determines whether an encryption procedure has been requested by any appropriate entity for protecting the personal content. For example, encryption instructions may be provided in the transmission instructions or transmission request. If encryption is required, then the content server utilizes a unique encryption key to perform an encryption procedure upon the personal content. The content server then sends the finalized content item to the transmitter for broadcast. The transmitter may be implemented in any effective manner. For example, in certain embodiments, the transmitter wirelessly broadcasts electronic information unidirectionally to client devices in accordance with known or enhanced standards from an Advanced Television Standards Committee (ATSC).

The client devices continually analyze the transmitted broadcast stream from the transmitter in order to detect the broadcasted content item. In certain embodiments, the client devices determine whether a target ID is detected in the content header of the received content item to thereby identify the target client devices that are authorized to receive, access, and utilize the content item. If a given target client device detects a target ID, then the target client device may process information in the content header to effectively access and otherwise handle the received content item. For example, if the content header has an encryption flag set, then the target client device may utilize an appropriate key or password to decrypt the personal content from the content item.

The target client device may thus capture the downloaded personal content, and locally store the personal content in a device memory. Finally, a target device user may utilize the downloaded personal content in any appropriate manner. For at least the foregoing reasons, the present invention therefore provides an improved system and method for effectively supporting a personal content distribution procedure in an electronic network.

### BRIEF DESCRIPTION OF THE DRAWINGS

FIG. 1A is a block diagram of an electronic network, in accordance with one embodiment of the present invention;

FIG. 1B is a block diagram of the peer-to-peer network of FIG. 1A, in accordance with one embodiment of the present invention;

FIG. 1C is a block diagram of the transmitter of FIG. 1A, in accordance with one embodiment of the present invention;

FIG. 1D is a block diagram of the transmitter memory of FIG. 1C, in accordance with one embodiment of the present invention;

FIG. 2 is a block diagram for one embodiment of the content server of FIG. 1A, in accordance with the present invention;

FIG. 3 is a block diagram for one embodiment of the server memory of FIG. 2, in accordance with the present invention;

FIG. 4 is a block diagram of a content item from FIG. 3, in accordance with one embodiment of the present invention;

FIG. 5 is a block diagram for one embodiment of a client device from FIG. 1A, in accordance with the present invention;

FIG. 6 is a block diagram for one embodiment of the device memory of FIG. 5, in accordance with the present invention; and

FIGS. 7A and 7B are a flowchart of method steps for supporting a personal content distribution procedure, in accordance with one embodiment of the present invention.

### DETAILED DESCRIPTION

The present invention relates to an improvement in electronic information management techniques. The following description is presented to enable one of ordinary skill in the art to make and use the invention, and is provided in the context of a patent application and its requirements. Various modifications to the disclosed embodiments will be readily apparent to those skilled in the art, and the generic principles herein may be applied to other embodiments. Therefore, the present invention is not intended to be limited to the embodiments shown, but is to be accorded the widest scope consistent with the principles and features described herein.

The present invention comprises a system and method for supporting personal content distribution in an electronic network, and includes a source client device that selects and transfers personal content over a back channel. A content server receives and processes the personal content according to specific transmission instructions to thereby generating a corresponding content item. A high-power transmitter then wirelessly broadcasts the content item to one or more target client devices that receive and process the content item to retrieve the personal content.

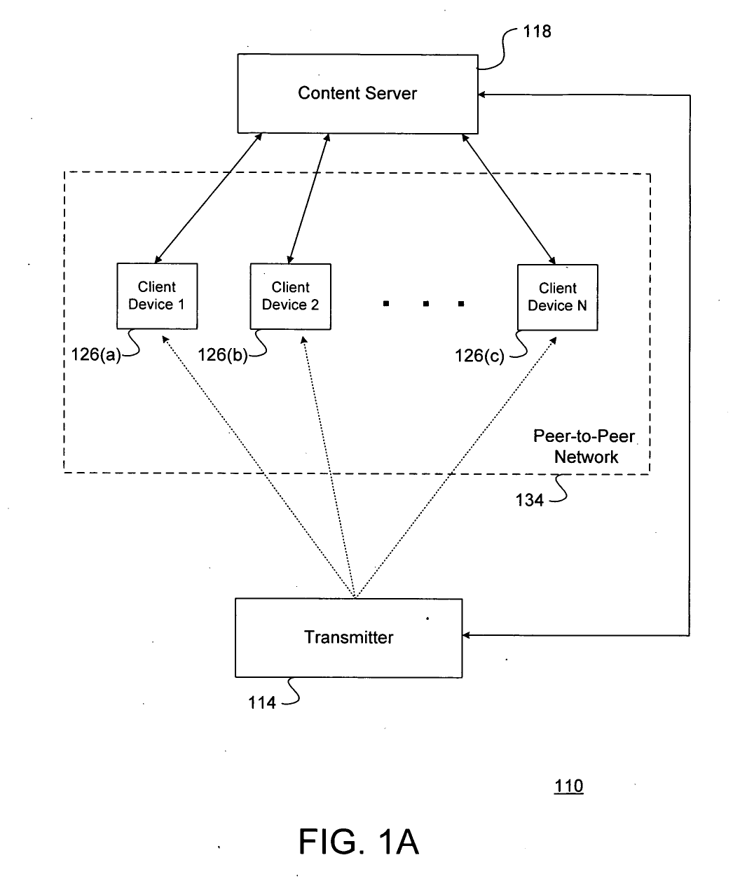

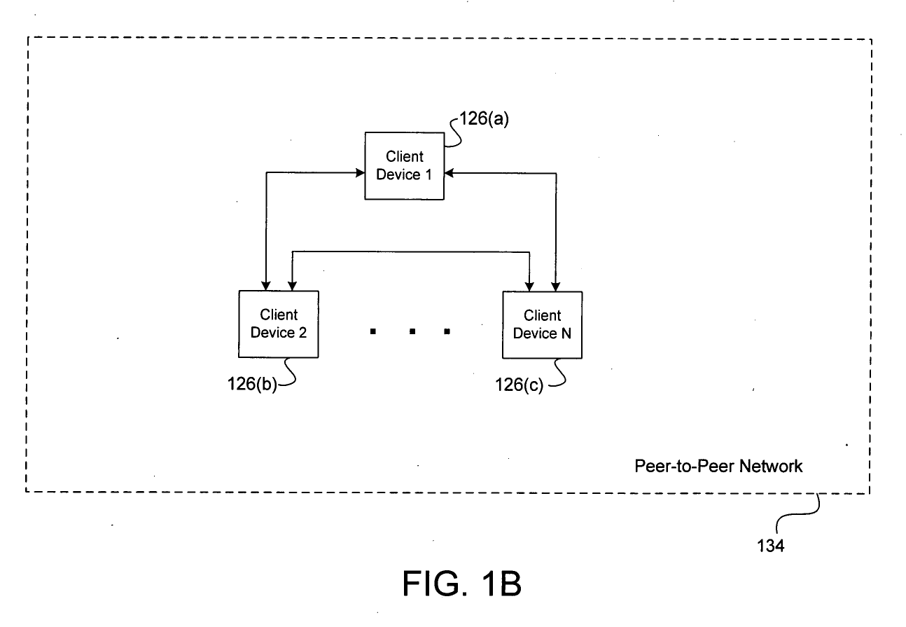

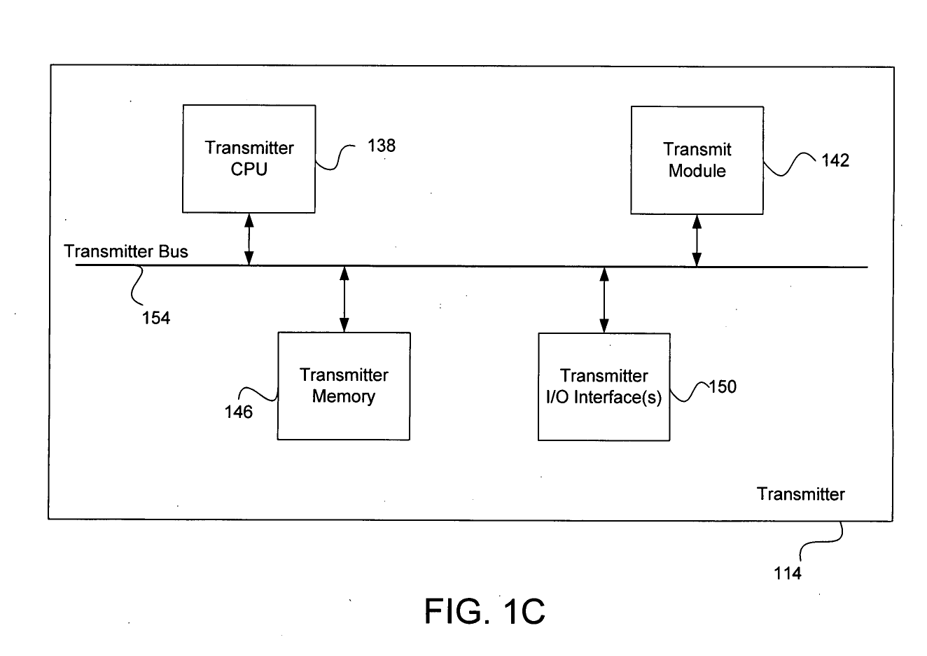

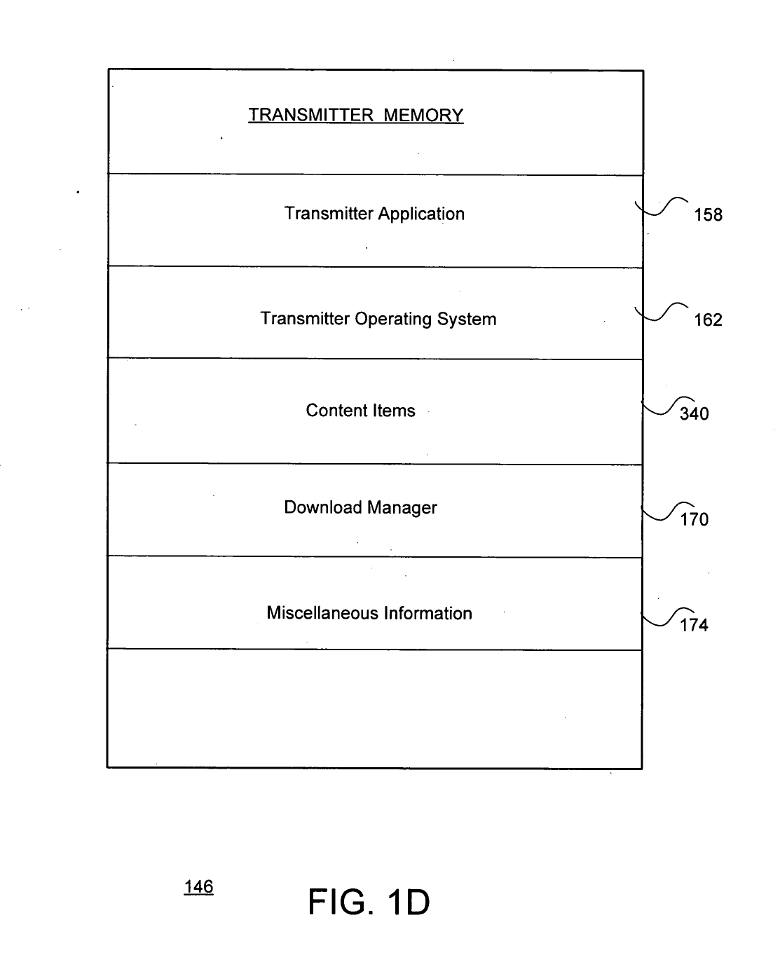

Referring now to FIG. 1A, a block diagram of an electronic network 110 is shown, in accordance with one embodiment of the present invention. In the FIG. 1A embodiment, electronic network 110 may include, but is not limited to, a transmitter 114, a content server 118, and a plurality of client devices 126. In alternate embodiments, electronic network 110 may be implemented by utilizing components and configurations in addition to, or instead of, certain of those components and configurations discussed in conjunction with the FIG. 1A embodiment.

In accordance with one embodiment of the present invention, any desired number of client devices 126 are contemplated, and may optionally be configured in a peer-to-peer network 134 that is further discussed below in conjunction with FIG. 1B. In certain alternate embodiments, some or all of the client devices 126 may not be included within peer-to-peer network 134. In the FIG. 1A embodiment, client devices 126 may include an electronic device 1 (126(a)) through an electronic device N 126(c). In the FIG. 1A embodiment, each of the client devices 126 may bi-directionally communicate directly with other ones of the client devices 126 by utilizing any appropriate peer-to-peer communication techniques or other effective communication methods.

In the FIG. 1A embodiment, the client devices 126 may provide any desired types of personal content or other information to content server 118 for storage. In the FIG. 1A embodiment, client devices 126 may securely communicate with content server 118 via a back channel or other appropriate means to provide the personal content. The back channel may include any effective communication path between the client devices 126 and content server 118. In certain embodiments, the back channel may include, but is not limited to, Internet connections between respective client devices 126 and content server 118.

The personal content may include any desired types of electronic information. For example, personal content may include, but is not limited to, video data, audio data, digital photographs, still image data, graphics, web pages, text data, and various types of software programs, etc. In certain embodiments, the client devices 126 may also provide transmission instructions and other relevant information regarding the uploaded personal content to content server 118 via the back channel.

In the FIG. 1A embodiment, the content server 118 may then handle the personal content in accordance with related instructions from any appropriate source. For example, a device user of a client device 126 may provide transmission instructions for uploaded personal content. In addition, a download request may be sent from one or more target devices 126 to access particular content items from content server 118. In response, the content server 118 may prepare and send stored content items to transmitter 114 for broadcasting to one or more appropriate target devices 126. In the FIG. 1A embodiment, content server 118 performs one or more security procedures to ensure that only authorized target devices 126 are able to access and utilize the content items.

In the FIG. 1A embodiment, transmitter 114 may then perform a multicast procedure to simultaneously broadcast a unidirectional data stream that includes one or more appropriate content items to the client devices 126. In the FIG. 1A embodiment, transmitter 114 may be implemented as a high-power wireless radio-frequency transmitter device that has a transmission range of approximately fifty miles or more, depending upon the selected operating frequency and operating power. In the FIG. 1A embodiment, one or more authorized target devices 126 may then wirelessly receive the broadcast content item(s) and utilize various types of effective verification measures to identify and access the personal content received from transmitter 114.

The present invention thus supports secure broadcasts of personal content such as HDTV, video information, personal videos, audio recordings, etc. The personal content is uploaded to content server 118 for the purpose of data backup, and so that the personal content can be transmitted to appropriate trusted destinations (e.g., friends and family). Pricing models for these secure downloads may depend on various factors such as required download speeds or the amount/value of content data being transmitted.

In one embodiment, the present invention may utilize standard or enhanced ATSC broadcast transmitters and towers to efficiently and securely multicast content items to user-selectable target devices 126. Personal content files are uploaded to content server 118 by utilizing the back-channel connection path. Appropriate content items may then be multicast from transmitter 114 to specific target devices 126 that are definable by the device users. Download speeds may vary from faster than real-time (burst mode) to extremely slow speeds when time is not a critical factor. New applications, such as HD video-conferencing or electronic classrooms, may be supported for device users if the back channel is fast enough to support the uploading procedures. Additional details regarding these personal content distribution procedures are further discussed below in conjunction with FIGS. 1B-7B.

Referring now to FIG. 1B, a block diagram of the FIG. 1A peer-to-peer network 134 is shown, in accordance with one embodiment of the present invention. The FIG. 1B embodiment includes a client device 1 (126(a)), a client device 2 (126(b)), through a client device N (126(a)). In alternate embodiments, peer-to-peer network 134 may be implemented by utilizing components and configurations in addition to, or instead of, certain of those components and configurations discussed in conjunction with the FIG. 1B embodiment. Furthermore, peer-to-peer network 134 may be implemented to include any desired number of client devices 126.

In the FIG. 1B embodiment, each of the client devices 126 may bi-directionally communicate directly with any other of the client devices 126 by utilizing any desired peer-to-peer communication techniques or other effective communication methods. For example, client device 1 (126(a)) may bi-directionally communicate directly with either client device 2 (126(b)) or client device N (126(c)). Similarly, client device 2 (126(b) may bi-directionally communicate directly with client device N (126(c)). Furthermore, in the FIG. 1B embodiment, any of the client devices 126 in peer-to-peer network 134 may perform a peer-to-peer content transfer procedure to transfer personal content to any of the other authorized client devices 126 in peer-to-peer network 134. Additional details regarding the utilization of the FIG. 1B peer-to-peer network 134 are further discussed below in conjunction with FIGS. 1C-7B.

Referring now to FIG. 1C, a block diagram for one embodiment of the FIG. 1A transmitter 114 is shown, in accordance with the present invention. In the FIG. 1C embodiment, transmitter 114 includes, but is not limited to, a transmitter central-processing unit (transmitter CPU) 138, a transmit module 142, a transmitter memory 146, and one or more transmitter input/output interface(s) (transmitter I/O interface(s)) 150. The foregoing components of transmitter 114 may be coupled to, and communicate through, a transmitter bus 154. In alternate embodiments, transmitter 114 may alternately be implemented using components and configurations in addition to, or instead of, certain of those components and configurations discussed in conjunction with the FIG. 1C embodiment.

In the FIG. 1C embodiment, transmitter CPU 138 may be implemented to include any appropriate and compatible microprocessor device that preferably executes software instructions to thereby control and manage the operation of transmitter 114. The FIG. 1C transmitter 114 may utilize transmit module 142 to send electronic information to one or more electronic devices 126 (FIG. 1A) by utilizing any effective type of wireless or wired communication techniques. For example, in certain embodiments, transmitter 114 may include a commercial television broadcast transmitter. Furthermore, in certain embodiments, transmitter 114 may be implemented to broadcast electronic information according to standard or enhanced standards from the Advanced Television Standards Committee (ATSC).

In the FIG. 1C embodiment, transmitter memory 146 may be implemented to include any combination of desired storage devices, including, but not limited to, read-only memory (ROM), random-access memory (RAM), and various types of non-volatile memory, such as floppy disks, memory sticks, compact disks, or hard disks. The contents and functionality of transmitter memory 146 are further discussed below in conjunction with FIG. 1D.

In the FIG. 1C embodiment, transmitter I/O interface(s) 150 may include one or more input and/or output interfaces to receive and/or transmit any required types of information by transmitter 114. Transmitter I/O interface(s) 150 may include one or more means for allowing a transmitter user to communicate, with transmitter 114. In the FIG. 10 embodiment, transmit module 142 may include any appropriate technologies to support broadcasts from transmitter 114 to client devices 126 (FIG. 1A). For example, in certain embodiments, transmit module 142 may include a high-voltage transmission power supply, radio-frequency transmitter hardware components, and a broadcasting antennae array that is mounted on an elevated broadcasting tower to support long-range wireless multicasts to client devices 126. The implementation and utilization of transmitter 114 is further discussed below in conjunction with FIGS. 1D-7B.

Referring now to FIG. 1D, a block diagram for one embodiment of the FIG. 1C transmitter memory 146 is shown, in accordance with the present invention. In the FIG. 1D embodiment, transmitter memory 146 may include, but is not limited to, a transmitter application 158, a transmitter operating system 162, one or more content items 340, a download manager 170, and miscellaneous information 174. In alternate embodiments, transmitter memory 146 may include various other components and functionalities in addition to, or instead of, certain those components and functionalities discussed in conjunction with the FIG. 1D embodiment.

In the FIG. 1D embodiment, transmitter application 158 may include program instructions that are preferably executed by transmitter CPU 138 (FIG. 1C) to perform various functions and operations for transmitter 114. The particular nature and functionality of transmitter application 158 typically varies depending upon factors such as the specific type and particular functionality of the corresponding transmitter 114. Transmitter operating system 162 may perform various low-level functions for transmitter 114.

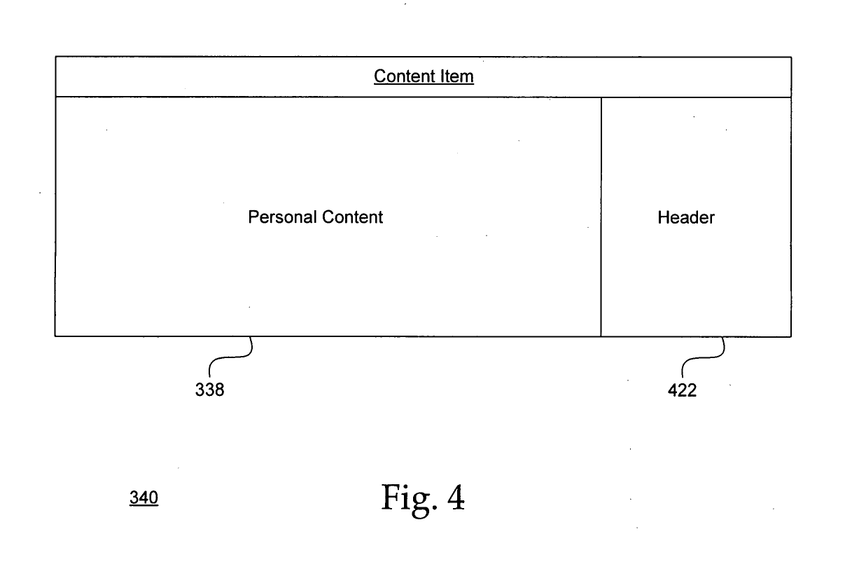

In the FIG. 1D embodiment, content items 340 may include any appropriate type of personal content or other information received by transmitter application 158 from content server 118 (FIG. 1A) or other appropriate entity. For example, in certain embodiments, content items 340 may include, but are not limited to, any types of video data, audio data, digital photographs, still image data, graphics, web pages, text data, and various types of software programs, etc. One embodiment for a content item 340 is further discussed below in conjunction with FIG. 4.

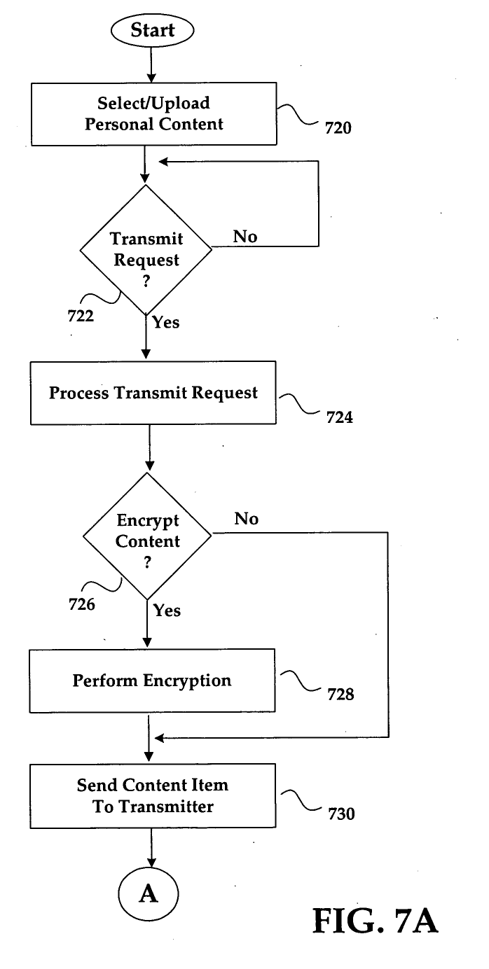

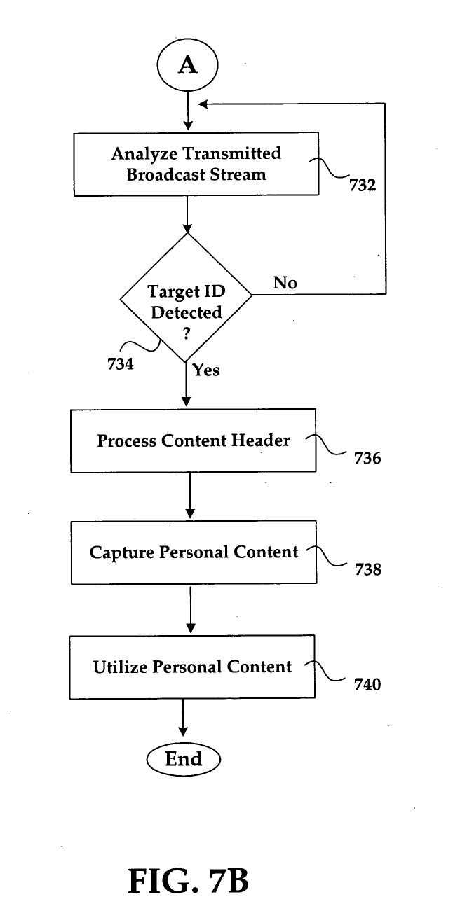

In the FIG. 1D embodiment, download manager 170 may be utilized to coordinate transmission procedures to concurrently transmit television programming as well as content item distribution, in accordance with the present invention. In the FIG. 1D embodiment, miscellaneous information 174 may include any appropriate additional information or data that is required by transmitter 114. Additional details regarding the operation of transmitter 118 are further discussed below in conjunction with FIG. 7.

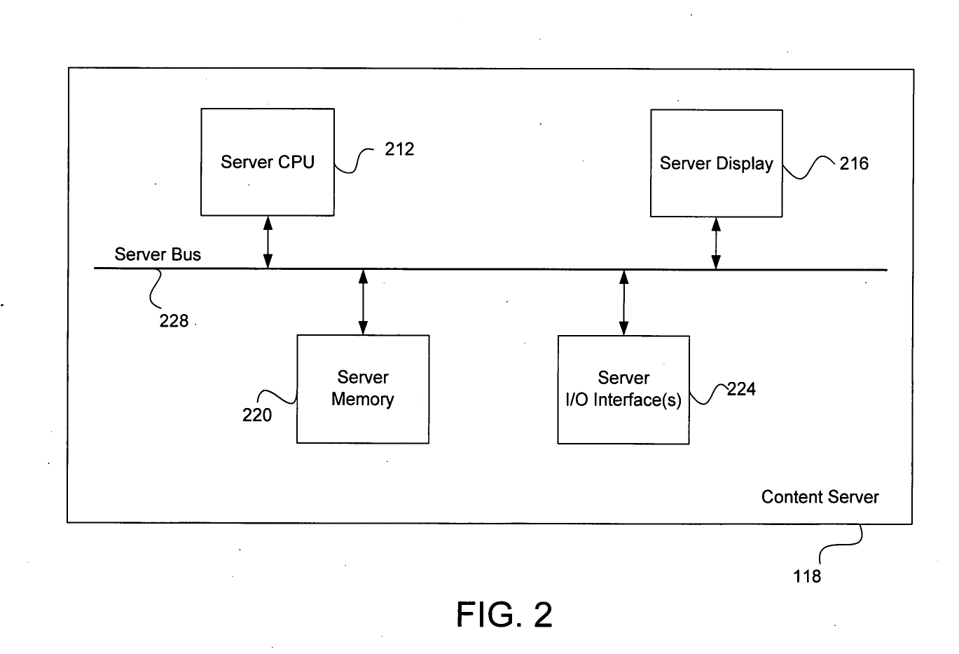

Referring now to FIG. 2, a block diagram for one embodiment of the FIG. 1A content server 118 is shown, in accordance with the present invention. In the FIG. 2 embodiment, content server 118 includes, but is not limited to, a server central processing unit (server CPU) 212, a server display 216, a server memory 220, and one or more server input/output interface(s) (server I/O interface(s)) 224. The foregoing components of content server 118 may be coupled to, and communicate through, a server bus 228. In alternate embodiments, content server 118 may alternately be implemented using components and configurations in addition to, or instead of, certain of those components and configurations discussed in conjunction with the FIG. 2 embodiment.

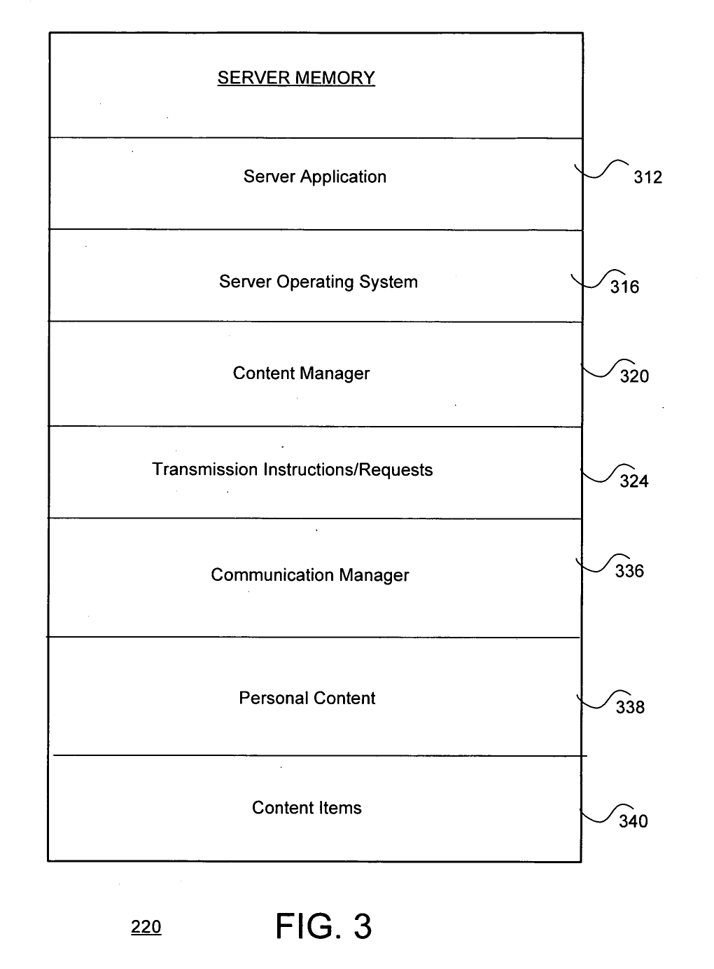

In the FIG. 2 embodiment, server CPU 212 may be implemented to include any appropriate and compatible microprocessor device that preferably executes software instructions to thereby control and manage the operation of content server 118. The FIG. 2 server display 216 may include any effective type of display technology including a cathode-ray-tube monitor or a liquid-crystal display device with an appropriate screen for displaying various information to a server user. In the FIG. 2 embodiment, server memory 220 may be implemented to include any combination of desired storage devices, including, but not limited to, read-only memory (ROM), random-access memory (RAM), and various types of non-volatile memory, such as floppy disks, memory sticks, compact disks, or hard disks. The contents and functionality of server memory 220 are further discussed below in conjunction with FIG. 3.

In the FIG. 2 embodiment, server I/O interface(s) 224 may include one or more input and/or output interfaces to receive and/or transmit any required types of information by content server 118. Server I/O interface(s) 224 may include one or more means for allowing a server user to communicate with content server 118. The utilization of content server 118 is further discussed below in conjunction with FIGS. 3-4 and 7.

Referring now to FIG. 3, a block diagram for one embodiment of the FIG. 2 server memory 220 is shown, in accordance with the present invention. In the FIG. 3 embodiment, server memory 220 may include, but is not limited to, a server application 312, a server operating system 316, a content manager 320, transmission instructions/requests 324, a communication manager 336, personal content 338, and content items 340. In alternate embodiments, server memory 220 may include various other components and functionalities in addition to, or instead of, certain those components and functionalities discussed in conjunction with the FIG. 3 embodiment.

In the FIG. 3 embodiment, server application 312 may include program instructions that are preferably executed by server CPU 212 (FIG. 2) to perform various functions and operations for content server 118. The particular nature and functionality of server application 312 typically varies depending upon factors such as the specific type and particular functionality of the corresponding content server 118. Server operating system 316 may perform various low-level functions for content server 118.

In the FIG. 3 embodiment, content manager 320 may include any effective means for managing personal content distribution procedures. For example, content manager 320 may coordinate an upload procedure of personal content 338 from various client devices 126 (FIG. 1A). In addition, content manager 320 may convert appropriate personal content 338 into corresponding content items 340 in response to transmission instructions/requests 324 from any appropriate request source including, but not limited to, a source device 126 that uploaded the personal content 338 and/or one or more target devices 126 that require access to the personal content 338.

The content items 340 may then be provided by content server 118 to transmitter 114 (FIG. 1A) for broadcast. In the FIG. 3 embodiment, communication manager 336 may perform appropriate communication functions with client devices 126 and transmitter 114 to transfer any appropriate type of information. Additional details regarding the operation and implementation of content server 118 are further discussed below in conjunction with FIGS. 4 and 7.

Referring now to FIG. 4, a block diagram of a FIG. 3 content item 340 is shown, in accordance with one embodiment of the present invention. In the FIG. 4 embodiment, content item 340 may include, but is not limited to, one or more types of personal content 338 and a corresponding content header 422. In alternate embodiments, content item 340 may readily be implemented using various components and configurations in addition to, or instead of, those discussed in conjunction with the FIG. 4 embodiment.

In the FIG. 4 embodiment, personal content 338 may include any appropriate information. For example, personal content 338 may include video and/or audio information, as well as text and/or graphics information, for utilization by a target client device 126. In the FIG. 4 embodiment, content server 118 (FIG. 1A) may create a given content item 340 in any effective manner according to transmission instructions and/or requests 324 provided by an appropriate instruction/request source. For example, in certain embodiments, a content manager 320 of content server 118 may perform an encryption procedure upon personal content 338 using an encryption key that is also provided to authorized target devices 126 for decrypting the personal content 338 after broadcast via transmitter 114 (FIG. 1A).

In addition, the content manager 320 may create and populate a content header 422 for a given content item 340 in any effective manner to provide relevant information that allows target devices 126 to access and utilize the transmitted content item 340. For example, content server 118 may include one or more target identifiers (target IDs) in header 422 to specifically identify target client devices 126 that are authorized to receive, process, and store content items 340 that are broadcast from transmitter 114. In certain embodiments, the target IDs may be implemented as unique serial numbers corresponding to respective ones of the target client devices 126.

In certain embodiments, an authorized target device 126 has a local copy of the target ID, and can receive, store, and utilize personal content 338 only when the local copy of the target ID matches the target ID in the content header 420. In the FIG. 4 embodiment, header 420 may also store any other relevant information about personal content 338 including, but not limited to, an encryption status flag, a content format, a content size, and a content name. The present invention therefore provides a multi-level security process to ensure that only authorized target devices 126 have access to personal content 338. Additional details regarding the handling of content item 340 are further discussed below in conjunction with FIG. 7.

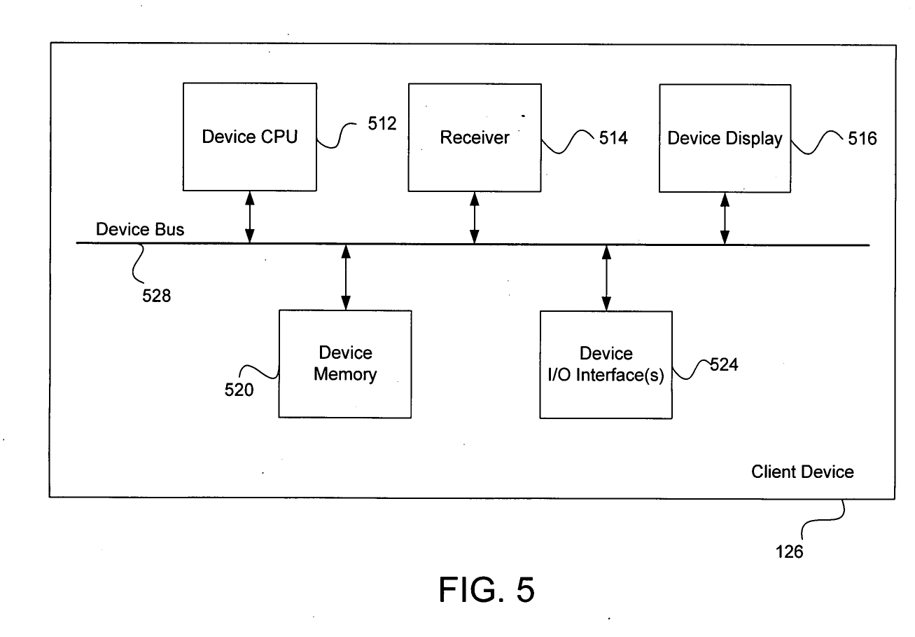

Referring now to FIG. 5, a block diagram for one embodiment of a FIG. 1A client device 126 is shown, in accordance with the present invention. In the FIG. 5 embodiment, client device 126 may include, but is not limited to, a device central processing unit (device CPU) 512, a receiver 514, a device display 516, a device memory 520, and one or more device input/output interface(s) (device I/O interface(s)) 524. The foregoing components of client device 126 may be coupled to, and communicate through, a device bus 528.

In alternate embodiments, client device 126 may readily be implemented using various components and configurations in addition to, or instead of, certain of those components and configurations discussed in conjunction with the FIG. 5 embodiment. Furthermore, in the FIG. 5 embodiment, client device 126 may be implemented as any type of appropriate electronic device. For example, in certain embodiments, client device 126 may be implemented as any type of stationary or portable electronic device, such as a personal computer, a television, a consumer-electronics device, a cellular telephone, a settop box, an audio-visual entertainment device, or a personal digital assistant (PDA).

In the FIG. 5 embodiment, device CPU 512 may be implemented to include any appropriate and compatible microprocessor device that preferably executes software instructions to thereby control and manage the operation of client devices 126. In the FIG. 5 embodiment, receiver 514 may include any effective means of receiving broadcasts or transmissions from an external entity. For example, receiver 514 may be configured to wirelessly receive transmissions from transmitter 114, as discussed above in conjunction with FIG. 1A.

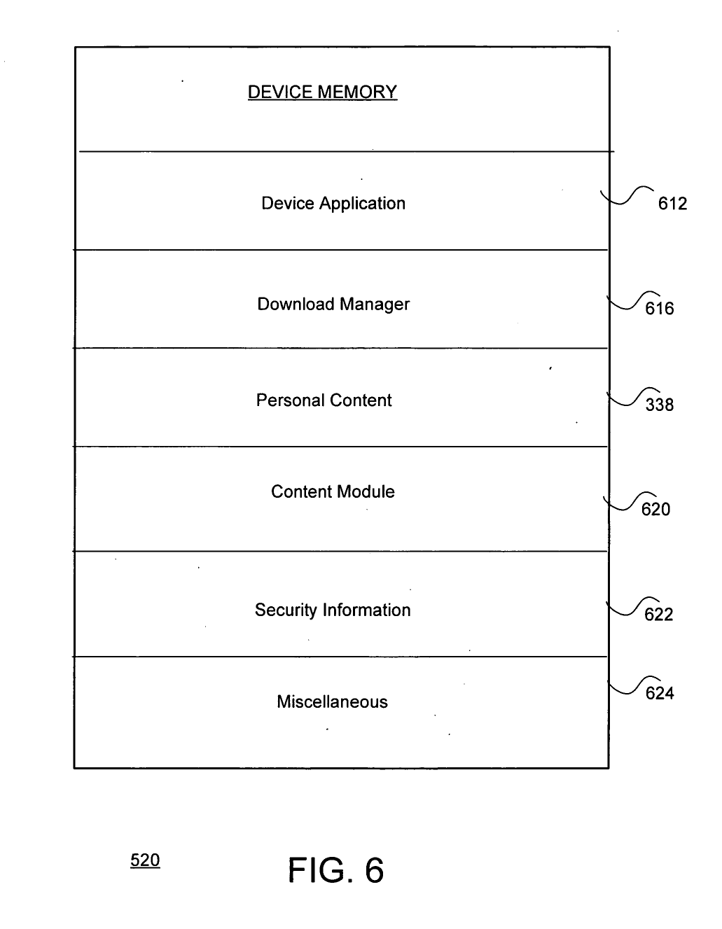

The FIG. 5 device display 516 may include any effective type of display technology including a cathode-ray-tube monitor or a liquid-crystal display device with an appropriate screen for displaying various information to a device user. In the FIG. 5 embodiment, device memory 520 may be implemented to include any combination of desired storage devices, including, but not limited to, read-only memory (ROM), random-access memory (RAM), and various types of non-volatile memory, such as floppy disks, memory sticks, compact disks, or hard disks. The contents and functionality of device memory 520 are further discussed below in conjunction with FIG. 6.

In the FIG. 5 embodiment, device I/O interface(s) 524 may include one or more input and/or output interfaces to receive and/or transmit any required types of information by client device 126. Device I/O interface(s) 524 may include one or more means for allowing a device user to communicate with other entities in electronic network 110 (FIG. 1A). For example, the foregoing means may include a keyboard device, a wireless remote-control device, a speech-recognition module with corresponding microphone, a graphical user interface with touch-screen capability, a hand-held device controller unit, or a selection button array mounted externally on client device 126. The implementation and utilization of client device 126 are further discussed below in conjunction with FIGS. 6-7.

Referring now to FIG. 6, a block diagram for one embodiment of the FIG. 5 device memory 520 is shown, in accordance with the present invention. In the FIG. 6 embodiment, device memory 520 includes, but is not limited to, a device application 612, a download manager 616, personal content 338, a content module 620, security information 622, and miscellaneous items 624. In alternate embodiments, device memory 520 may include components and functionalities in addition to, or instead of, certain of those components and functionalities discussed in conjunction with the FIG. 6 embodiment.

In the FIG. 6 embodiment, device application 612 may include program instructions that are preferably executed by a device CPU 512 (FIG. 5) to perform various functions and operations for a client device 126. The particular nature and functionality of device application 612 typically varies depending upon factors such as the specific type and particular functionality of the corresponding client device 126.

In the FIG. 6 embodiment, download manager 616 may perform communication procedures for exchanging electronic information with external entities by utilizing any appropriate techniques. For example, download manager 616 may coordinate personal content download procedures to automatically receive and locally store broadcasted content items 340 from transmitter 114 (FIG. 1A). In the FIG. 6 embodiment, personal content 338 may include either personal content 338 that was broadcast from transmitter 114 on the behalf of other client devices 126, or personal content 338 that was previously uploaded to content server 118 for storage.

In the FIG. 6 embodiment, content module 620 may be utilized by a particular client device 126 to either upload personal content 338 to content server 118 via an appropriate back channel, or to receive and convert broadcasted content items 340 (FIG. 4) into personal content 338. For example, content module 620 may utilize security information 622 to convert a received content item 340 into corresponding personal content 338. In certain embodiments, security information 622 may include an encryption key that content module 620 may utilize to decrypted personal content 338 received from content server 118.

In addition, security information 622 may include a target ID that content module 620 compares with information in a content header 422 (FIG. 4) to ensure that a given client device 126 is authorized to receive and utilize personal content 338 from a particular broadcasted content item 340. Miscellaneous information 624 may include any additional information that for utilization by client device 126. The implementation and utilization of client device 126 is further discussed below in conjunction with FIG. 7.

Referring now to FIGS. 7A and 7B, a flowchart of method steps for supporting a personal content distribution procedure is shown, in accordance with one embodiment of the present invention. The FIG. 7 flowchart is presented for purposes of illustration, and in alternate embodiments, the present invention may utilize steps and sequences other than those steps and sequences discussed in conjunction with the FIG. 7 embodiment.

In step 720 of FIG. 7A, a source device user of a source client device 126 initially selects and uploads personal content 338 to a content server 118 via a back channel. In certain embodiments, the back channel may include an Internet connection between the source client device 126 and the content server 118. In certain embodiments, the source device user may also provide appropriate transmission instructions 324 for handling the uploaded personal content 338 in any effective manner. For example, default transmission instructions 324 may be provided when the source device user registers for a user account with the content server 118. Furthermore, special transmission instructions (for example, instructions identifying specific authorized target client devices 126) may be specified for each upload of personal content 338.

In step 722, the content server 118 determines whether a transmit request 324 has been received to request the broadcast of the uploaded personal content 338 from a transmitter 114 (FIG. 1A). In the FIG. 7 embodiment, transmit requests 722 may be generated by any appropriate request source including, but not limited to, the source client device 126 and one or more target client devices 126. In step 724, content server 118 processes the transmit request 324 to create a content header 422 that is configured depending upon any pre-existing transmission instructions 324 and/or specific information and instructions provided by the request source.

For example, a source client device 126 may identify specific target client devices 126 that are authorized to receive the personal content 338, or target client device 126 may specify an appropriate transmission time or transmission speed. In the FIG. 7A embodiment, content server 118 may attach the content header 422 to the personal content 338 to form a content item 340 for broadcast by the transmitter 114.

In step 726, content server 118 determines whether an encryption procedure has been requested by any appropriate entity for protecting the personal content 338. For example, encryption instructions may be provided in transmission instructions/requests 324 (FIG. 3). If encryption is required, then in step 728, content server 118 utilizes a unique encryption key to perform an encryption procedure upon the personal content 338. In step 730, the content server 118 then sends the finalized content item 340 to the transmitter 114 for broadcast. The transmitter 114 may be implemented in any effective manner. For example, in certain embodiments, the transmitter 114 wirelessly broadcasts electronic information unidirectionally to client devices 126 in accordance with known or enhanced standards from an Advanced Television Standards Committee (ATSC). The FIG. 7A process then advances to step 732 of FIG. 7B through connecting letter “A.”

In step 732, client devices 126 continually analyze the transmitted broadcast stream from the transmitter 114 to recognize the broadcasted content item 340. In step 734, the client devices 126 determine whether a target ID is detected in the header 422 of the received content item 340 to thereby identify target client devices 126 that are authorized to receive, access, and utilize the content item 340. If a given target client device 126 detects a target ID, then in step 736, the target client device 126 may process information in the content header 422 to effectively handle the received content item 340. For example, if the content header 422 has an encryption flag set, then the target client device 126 may utilize an appropriate unique key or password to decrypt the personal content 338 in the content item 340.

In step 738, the target client device 126 may thus capture the downloaded personal content 338, and locally store the personal content 338 in a device memory 520. Finally, in step 740, a target device user may utilize the downloaded personal content 338 in any appropriate manner. The FIG. 7 process may then terminate. For at least the foregoing reasons, the present invention therefore provides an improved system and method for effectively supporting a personal content distribution procedure in an electronic network.

The invention has been explained above with reference to certain embodiments. Other embodiments will be apparent to those skilled in the art in light of this disclosure. For example, the present invention may readily be implemented using certain configurations and techniques other than those described in the specific embodiments above. Additionally, the present invention may effectively be used in conjunction with systems other than those described above. Therefore, these and other variations upon the discussed embodiments are intended to be covered by the present invention, which is limited only by the appended claims.

What is claimed is:

1. A system for supporting content distribution in an electronic network, comprising:
a source client device that transfers personal content over a back channel;
a content server that stores and processes said personal content according to transmission instructions to generating a content item;
a transmitter that broadcasts said content item; and
one or more target client devices that receive and process said content item to retrieve said personal content.

2. The system of claim 1 wherein said back channel includes an Internet communication path between said source client device and said content server.

3. The system of claim 1 wherein said transmitter is implemented as a high-power wireless transmitter device that broadcasts said advertisements according to transmission standards that are defined by an Advanced Television Systems Committee.

4. The system of claim 1 wherein said content distribution is performed to support a video conferencing procedure between said source client device and said one or more target client devices.

5. The system of claim 1 wherein said personal content includes video data, audio data, digital photographs, still image data, graphics, web pages, text data, and software programs.

6. The system of claim 1 wherein said transmission instructions are provided by a source device user of said source device to provide specific instructions for handling said personal content.

7. The system of claim 1 wherein said content server creates said content item in response to a transmit request from said source client device or one of said target client devices, said transmit request including identifications of said one or more target client devices, and one or more transmission times for broadcasting said content item

8. The system of claim 1 wherein said content server performs an encryption procedure upon said personal content to ensure that only authorized ones of said target client devices are able to access and utilize said personal content.

9. The system of claim 1 wherein said content server creates a content header for said content item to ensure that only authorized ones of said target client devices are able to access and utilize said personal content, said content header including one or more target identifiers that said target client devices match to access and process said content item.

10. The system of claim 1 wherein transmitter broadcasts said content item with a variable transmission speed that includes a burst transmission speed that is faster than real time, and an extended transmission speed that is slower than real time.

11. An electronic device for supporting content distribution in an electronic network, comprising:
an application program that receives personal content from a source client device over a back channel;
a content manager that processes said personal content according to transmission instructions to generate a content item;
a communication manager that provides said content item to a transmitter for broadcasting to one or more target client devices; and
a processor that controls said application program, said content manager, and said communication manager.

12. The electronic device of claim 11 wherein said back channel includes an Internet communication path between said source client device and said content server.

13. The electronic device of claim 11 wherein said transmitter is implemented as a high-power wireless transmitter device that broadcasts said advertisements according to transmission standards that are defined by an Advanced Television Systems Committee.

14. The electronic device of claim 11 wherein said content distribution is performed to support a video conferencing procedure between said source client device and said one or more target client devices.

15. The electronic device of claim 11 wherein said personal content includes video data, audio data, digital photographs, still image data, graphics, web pages, text data, and software programs.

16. The electronic device of claim 11 wherein said transmission instructions are provided by a source device user of said source device to provide specific instructions for handling said personal content.

17. The electronic device of claim 11 wherein said content server creates said content item in response to a transmit request from said source client device or one of said target client devices, said transmit request including identifications of said one or more target client devices, and one or more transmission times for broadcasting said content item

18. The electronic device of claim 11 wherein said content server performs an encryption procedure upon said personal content to ensure that only authorized ones of said target client devices are able to access and utilize said personal content.

19. The electronic device of claim 11 wherein said content server creates a content header for said content item to ensure that only authorized ones of said target client devices are able to access and utilize said personal content, said content header including one or more target identifiers that said target client devices match to access and process said content item.

20. The electronic device of claim 11 wherein transmitter broadcasts said content item with a variable transmission speed that includes a burst transmission speed that is faster than real time, and an extended transmission speed that is slower than real time.
